(19) United States
(12) Patent Application Publication
(10) Pub. No.: US 2019/0229401 A1
(43) Pub. Date: Jul. 25, 2019

(54) ANTENNA ASSEMBLY AND MOBILE TERMINAL

(71) Applicant: AAC Technologies Pte. Ltd., Singapore city (SG)

(72) Inventors: Zhengdong Yong, Shenzhen (CN); Wei Zhao, Shenzhen (CN); Xiaoyue Xia, Shenzhen (CN); Chao Wang, Shenzhen (CN)

(21) Appl. No.: 16/234,558

(22) Filed: Dec. 27, 2018

(30) Foreign Application Priority Data
Jan. 25, 2018 (CN) 201810070596.0

(51) Int. Cl. H01Q 1/24; H01Q 21/06; H04M 1/02

(52) U.S. Cl. CPC H01Q 1/243; H01Q 21/062; H04M 1/026; H01Q 21/065; H01Q 21/064

(57) ABSTRACT

The present disclosure provides an antenna assembly, including a housing, at least one group of antennas disposed in the housing, and a phase shifter connected to each group of antennas. A wave-transparent structure configured to allow a radio frequency signal to transmit is disposed on the housing and at a position corresponding to each group of antennas. The wave-transparent structure includes a plurality of slits arranged in an array for the antenna. Compared with the related art, according to the antenna assembly provided in the present disclosure, the wave-transparent structure including the plurality of slits arranged in an array for the antenna is disposed on the housing. The antenna performs scanning within a relatively wide spatial range, and further, the antenna assembly has beneficial effects of desirable aesthetics, fast thermal diffusion, and good radiation performance, antenna gains, and space coverage.

### CROSS-REFERENCE TO RELATED APPLICATIONS

This application claims the priority benefit of Chinese Patent Applications Ser. No. 201810070596.0 filed on Jan. 25, 2018, the entire content of which is incorporated herein by reference.

### TECHNICAL FIELD

The present disclosure relates to antenna technologies, and in particular, to an antenna assembly and a mobile terminal.

### BACKGROUND

In a wireless communication device, there is always an apparatus radiating electromagnetic energy to space and receiving electromagnetic energy from space, and the apparatus is an antenna. A function of the antenna is transmitting, to a spatial wireless channel, a digital signal or an analog signal that is modulated to a radio-frequency frequency or receiving, from a spatial wireless channel, a digital signal or an analog signal modulated to a radio-frequency frequency.

5G is a research and development focus in the industry of the world, and development of 5G technologies and setting of 5G standards have become a consensus of the industry. The International Telecommunication Union ITU defines three main application scenarios, that is, an enhanced mobile broadband, massive machine type communications, and ultra-reliable and low-latency communications, of 5G on the 22nd conference hold by ITU-RWPSD in June 2015. The three application scenarios respectively correspond to different key indicators. In the scenario of the enhanced mobile broadband, a user peak rate is 20 Gbps, and a lowest user experience rate is 100 Mbps. Characteristics of a high carrier frequency and large bandwidth that are specific to a millimeter wave is a main means of achieving a super-high data transmission rate in 5G.

Abundant bandwidth resources in a frequency band of the millimeter wave ensure the high transmission rate. However, due to severe space loss of an electromagnetic wave in the frequency band, a wireless communication system using the frequency band of the millimeter wave requires a phased array architecture. In the related art, phases of array elements are distributed according to a particular rule by using a phase shifter, so that a high-gain beam is formed, and the beam is enabled, through a phase shift change, to scan within a particular space.

A metal-frame structure is a mainstream solution in design of a mobile phone structure, and can provide better protection, aesthetics, thermal diffusion, and user experience. However, radiation performance of upper and lower antennas is seriously affected due to a shielding effect of metal on the electromagnetic wave, and consequently gains of the antennas are reduced.

Therefore, it is necessary to provide a novel antenna assembly to resolve the foregoing problems.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description merely show some embodiments of the present disclosure, and a person of ordinary skill in the art can derive other drawings from these accompanying drawings without creative efforts.

FIG. 1 is a schematic structural diagram of a mobile terminal according to the present disclosure;

FIG. 2 is a schematic structural diagram of an antenna assembly according to the present disclosure;

FIG. 3 is a schematic structural diagram of a wave-transparent structure of an antenna assembly according to the present disclosure;

FIG. 4 is a diagram of radio frequency signal transmittance of an antenna assembly according to the present disclosure;

FIG. 5 is a schematic diagram of beam pointing of an antenna assembly according to the present disclosure;

FIG. 6 is a diagram of an overall scanning mode of an antenna assembly according to the present disclosure; and

FIG. 7 is a diagram of coverage of an antenna assembly according to the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person skilled in the art based on the embodiments of the present disclosure without creative efforts shall fall within the protection scope of the present disclosure.

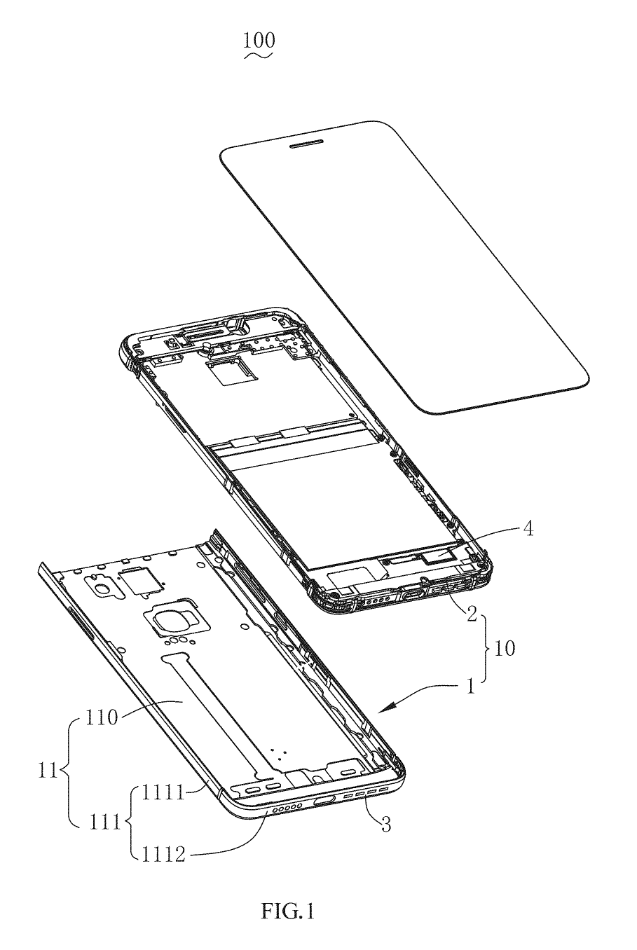

Referring to FIG. 1, an embodiment of the present disclosure provides an antenna assembly 10, applied to a mobile terminal 100, for example, a mobile phone. The antenna assembly 10 includes a housing 1, an antenna 2 and a speaker box 4 that are disposed in the housing 1, and a wave-transparent structure 3 disposed on the housing 1 and at a position corresponding to the antenna 2.

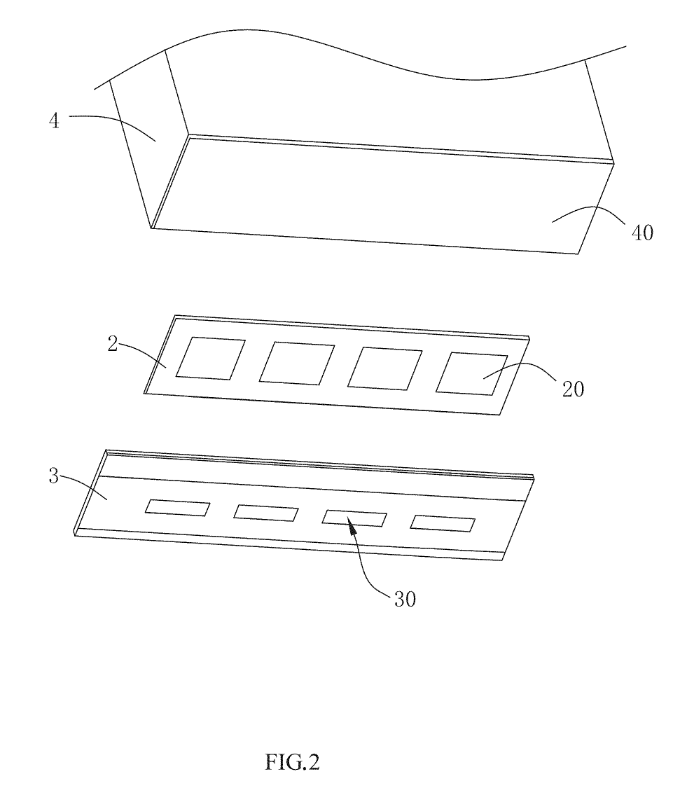

Referring to FIG. 2 together, the housing 1 includes a back cover 11, and the back cover 11 includes a cover body 110 and a metal frame 111 extending from the cover body 110. Inside the housing 1 is further provided the speaker box 4 having a sound hole 40. The wave-transparent structure 3 directly faces the sound hole 40 and is disposed on the metal frame 111. The antenna 2 is disposed between the wave-transparent structure 3 and the sound hole 40.

The antenna 2 is a millimeter-wave phased array antenna, and includes a plurality of antenna unit 20 sequentially disposed in an array in a peripheral direction of the metal frame 111.

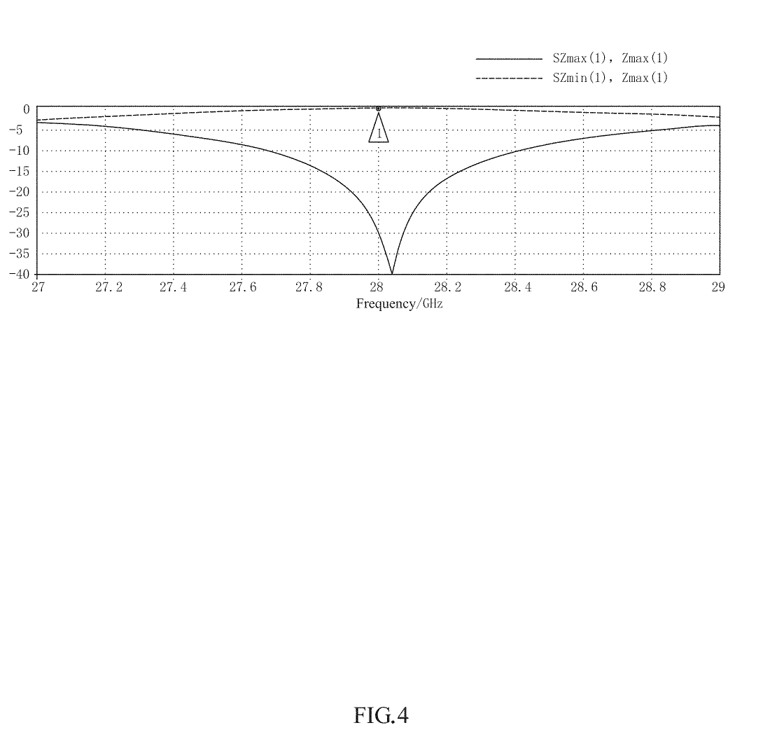

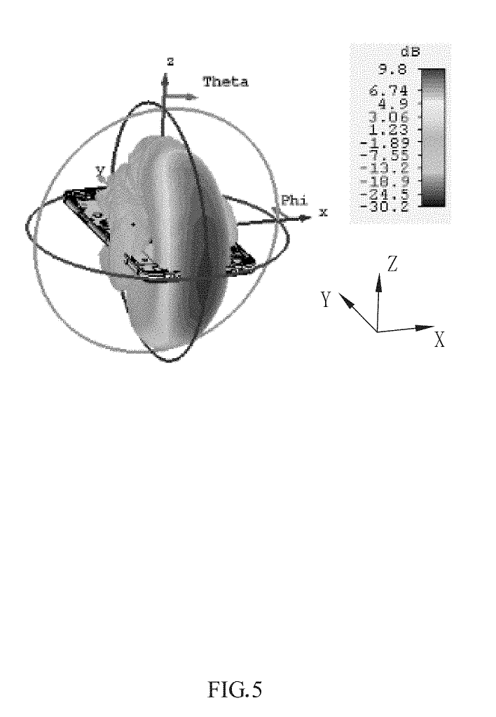

The wave-transparent structure 3 includes four slits 30 disposed in an array. In this implementation, the slits 30 are of a long-strip shape, have a length of 3.5 mm and a width of 1 mm, and are arranged in a one-dimensional linear array in the peripheral direction of the metal frame 111. The antenna 2 and the wave-transparent structure 3 are spaced by a distance and are coupled. A radio frequency signal of the antenna 2 transmits the slits 30 of the wave-transparent structure 3 and is radiated. A distance between two neighboring slits 30 is half an operating wavelength of the antenna 2. Therefore, actually, through layout design of the slots 30, the slot 30 can selectively allow the radio frequency signal of the antenna 2 to transmit. In this embodiment, as shown in FIG. 4, the radio frequency signal has extremely high transmittance at a frequency close to 28 GHz. As shown in FIG. 5, during equi-amplitude in-phase feeding of each antenna unit 20 of the antenna 2, a radiated beam transmits the wave-transparent structure 3 and points to an outer side of the metal frame 111.

In this embodiment, the metal frame 111 includes two long-side frames 1111 disposed opposite to each other and two short-side frames 1112 connected to the two long-side frames 1111. Generally, the long-side frames 1111 are used as a handheld part, and the short-side frames 1112 are used as a non-handheld part. The wave-transparent structure 3 is disposed on the short-side frame 112. Due to a design of the mobile terminal such as a mobile phone, the wave-transparent structure 3 is disposed on the short-side frame 112, so that a hand does not cover the wave-transparent structure 3, thereby more facilitating signal radiation and receiving of the antenna 2. Moreover, the wave-transparent structure 3 is disposed on the short-side frame 1112 at the bottom of the mobile terminal to be combined with the sound hole 40. The wave-transparent structure 3 is disposed at a position corresponding to the sound hole 40, to achieve a wave-transparent function and a sound output function, and an appearance of the mobile terminal is not affected.

In another embodiment, the wave-transparent structure 3 may be flexibly disposed in other positions, and is not limited to being disposed on the inner side of the metal frame 111 or the short-side frame 1112. Correspondingly, a position of the antenna 2 may also be flexibly disposed with the wave-transparent structure 3.

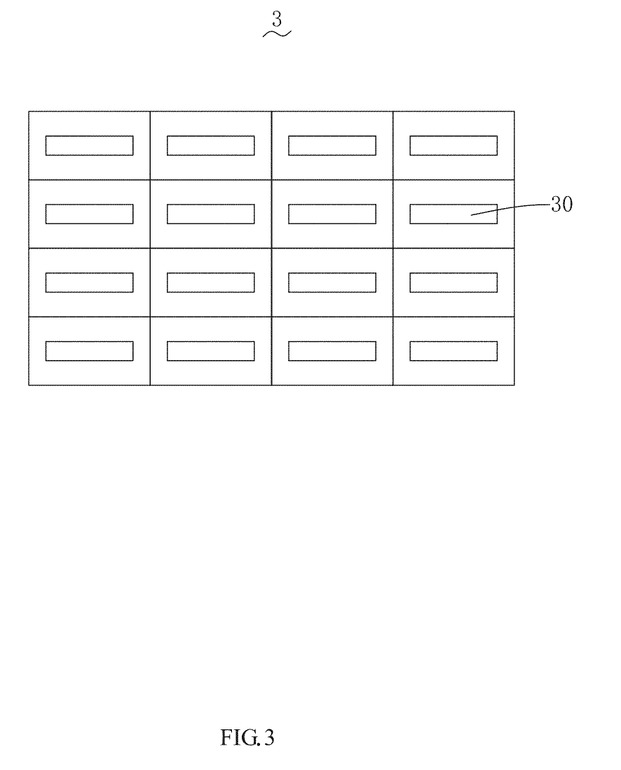

In another embodiment, the number and layout of the slits 30 may be both set according to an actual requirement. For example, when there are 16 slits 30, the 16 slits 30 may be arranged in an array of 4×4. Details are shown in FIG. 3.

Certainly, the shape of the slot 30 is not limited to the long-strip shape, and may alternatively be of any one of a ring shape, a U shape, and a cross shape. The protection scope of the present disclosure is not limited thereto, and the slot 30 of other equivalent shapes also falls within the protection scope of the present disclosure.

In this embodiment, the antenna 2 is any one of a patch antenna, a dipole antenna, and a planar horn antenna. The number of the antennas 2 may be set to an appropriate number according to an actual requirement. This should fall within the protection scope of the present disclosure.

In a preferred embodiment of the present disclosure, the antenna 2 is a coaxial-feeding patch antenna. In the manner of coaxial feeding, no radiation loss is generated when each antenna 2 transmits a signal. Besides, the antenna 2 is not interfered by an external signal, has a wider operating band, can be used for a band of a millimeter wave, and is very suitable for a super-high data transmission rate in 5G.

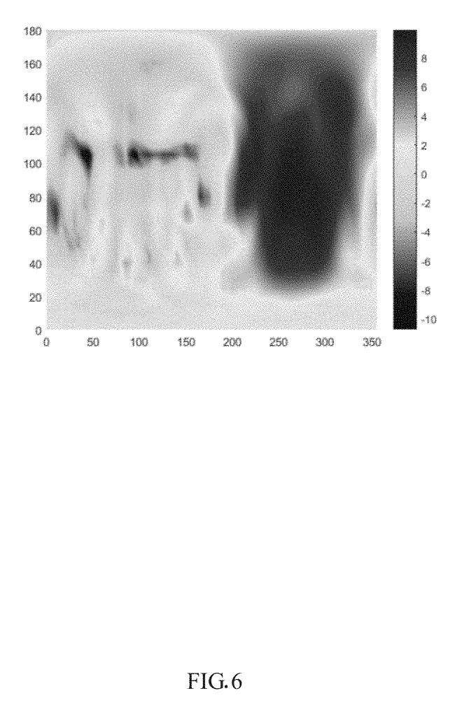

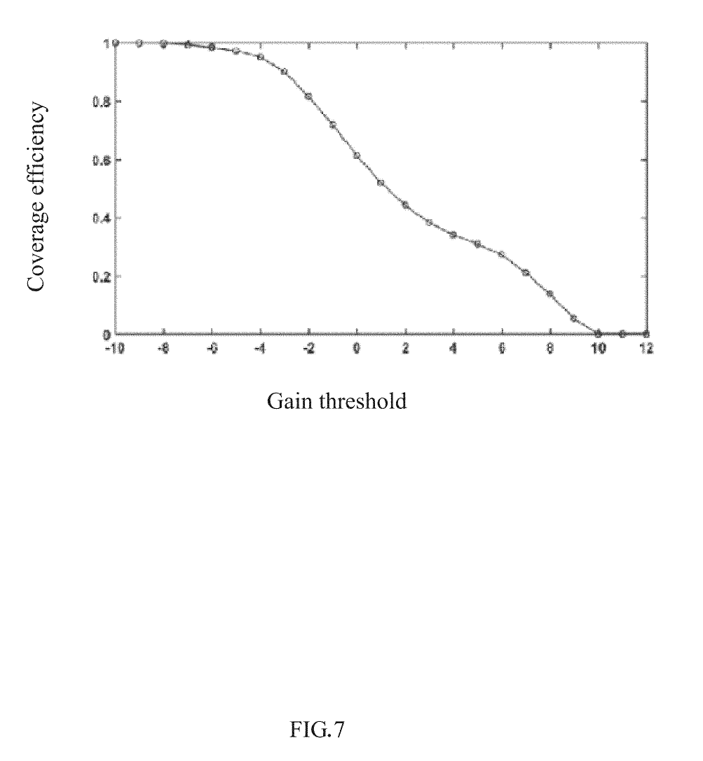

The housing 1 is further provided with a phase shifter (not shown in the figure), and the phase shifter is a 5-bit phase shifter with a precision of 11.25°. Certainly, it is also available to select a phase shifter having different parameter performance according to an actual requirement. This should all fall within the protection scope of the present disclosure. The phase shifter is disposed to adjust a phase of the signal radiated by the antenna 2, and the beam is scanned within a spatial range through a change of phase shift, thereby improving space coverage of the antenna assembly 10. For details, refer to FIG. 6 and FIG. 7. In FIG. 7, a unit of a horizontal coordinate is dB.

The present disclosure further provides a mobile terminal 100, including the antenna assembly 10.

Compared with the related art, according to the antenna assembly 10 provided in the present disclosure, the wave-transparent structure 3 including the plurality of slits 30 arranged in an array is disposed on the housing 1. The wave-transparent structure 3 can be used as a sound hole and can further be configured to allow the radio frequency signal to transmit, so that the antenna 2 performs scanning within a relatively wide spatial range, and further, the antenna assembly 10 has beneficial effects of desirable aesthetics, fast thermal diffusion, and good radiation performance, antenna gains, and space coverage.

The foregoing is merely embodiments of the present disclosure. It should be noted herein that a person of ordinary skill in the art may further make improvements without departing from the creative concept of the present disclosure, but these all fall within the protection scope of the present disclosure.

What is claimed is:

1. An antenna assembly, comprising
a housing and
an antenna disposed in the housing;
wherein a wave-transparent structure configured to allow a radio frequency signal to transmit is disposed on the housing and at a position corresponding to the antenna, and the wave-transparent structure comprises a plurality of slits arranged in an array.

2. The antenna assembly according to claim 1, wherein the plurality of slits are arranged in a two-dimensional planar array or a one-dimensional linear array.

3. The antenna assembly according to claim 1, wherein a distance between two neighboring slits is half an operating wavelength of the antenna.

4. The antenna assembly according to claim 1, wherein the slot is of any one of a long-strip shape, a ring shape, a U shape, and a cross shape.

5. The antenna assembly according to claim 1, wherein the slot is of a long-strip shape, and the slot has a length of 3.5 mm and a width of 1 mm.

6. The antenna assembly according to claim 1, wherein the housing comprises a back cover, the back cover comprises a cover body and a metal frame extending from the cover body, the antenna is disposed on an inner side of the metal frame, and the wave-transparent structure is disposed on the metal frame and at a position corresponding to the antenna.

7. The antenna assembly according to claim 6, wherein inside the housing is further provided a speaker box having a sound hole, the wave-transparent structure directly faces the sound hole, and the antenna is disposed between the wave-transparent structure and the sound hole.

8. The antenna assembly according to claim 6, wherein the antenna is a millimeter-wave phased array, and comprises a plurality of antenna units arranged in a peripheral direction of the metal frame.

9. The antenna assembly according to claim 1, wherein the antenna unit is any one of a patch antenna, a dipole antenna, and a planar horn antenna.

10. A mobile terminal, comprising the antenna assembly according to claim 1.
